(19) United States
(12) Patent Application Publication
(10) Pub. No.: US 2018/0286192 A1
(43) Pub. Date: Oct. 4, 2018

(54) BARRIER SHOCK DETECTOR ALARM SYSTEM

(71) Applicant: Brian DeAngelo, St. Charles, IL (US)

(72) Inventor: Brian DeAngelo, St. Charles, IL (US)

(21) Appl. No.: 15/476,888

(22) Filed: Mar. 31, 2017

(51) Int. Cl. G08B 13/04; G08B 13/10; G08B 25/00; G01L 5/00

(52) U.S. Cl. CPC G08B 13/04; G01L 5/0052; G08B 25/007; G08B 13/10

(57) ABSTRACT

An alarm system shock detector. The alarm system includes a pressure sensor, a transmitter and a computer having a processor and a memory. The pressure sensor detects an amount of pressure applied to a barrier. The computer is electrically connected to the pressure sensor and the transmitter. The computer receives an input of a threshold pressure amount, receives the amount of pressure from the pressure sensor when a pressure is applied to the barrier, and transmits an alarm signal to a remote command center via the transmitter when the amount of pressure exceeds the threshold pressure amount.

### BACKGROUND OF THE INVENTION

The present invention relates to alarm systems and, more particularly, to a barrier shock detector alarm system.

Current window breaching sensors cause a lot of false alarms. There are two types of window breaking detections systems, both of which result in a significant amount of false alarms. The first type are the window shock sensors that detect shock applied to the window even if the window is not broken, and so many false alarms result due to shock vibrations from storms or something hitting the window. The second type are the window breaking sensors that detect the sound of breaking glass, and so many false alarms result from similar sounding events being confused for the sound of breaking glass.

As can be seen, there is a need for improved alarm systems that utilize barrier shock detectors.

### SUMMARY OF THE INVENTION

In one aspect of the present invention, an alarm system comprises: a pressure sensor operable to detect an amount of pressure applied to a barrier; a transmitter; and a computer electrically connected to the pressure sensor and the transmitter, wherein the computer comprises a processor and a memory, wherein the processor receives an input of a threshold pressure amount; receives the amount of pressure from the pressure sensor when a pressure is applied to the barrier; and transmits an alarm signal to a remote command center via the transmitter when the amount of pressure exceeds the threshold pressure amount.

These and other features, aspects and advantages of the present invention will become better understood with reference to the following drawings, description and claims.

### BRIEF DESCRIPTION OF THE DRAWINGS

FIG. 1 is a schematic view of an embodiment of the present invention; and

FIG. 2 is a schematic view of a scanner of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a shock detector with threshold changeable pre-set threshold selector switches and threshold changeable pre-set threshold buttons. The present invention allows a user to set the pre-set threshold settings on the shock detector. A user may enter the pressure threshold that is required to break through the barrier or the person can set one or more desired pressure threshold settings. The pressure threshold(s) can be set and changed by electronic or manual means. When the shock detector detects at least the programmed pressure threshold on the barrier that is required to break through the barrier, then the alarm system is triggered. The barrier may include, but are not limited to, one or more doors, windows, ceilings and floors.

In certain embodiments, windows and other barriers include a barcode that is encoded with the window or barrier's breakage threshold. A barcode scanner is connected to the shock detector. The barcode code scanner scans the barcode and the encoded threshold that is encoded on the barcode is read and sent to a computer of the alarm system. The shock detector only triggers the alarm system when that threshold has been detected on the window or other barrier.

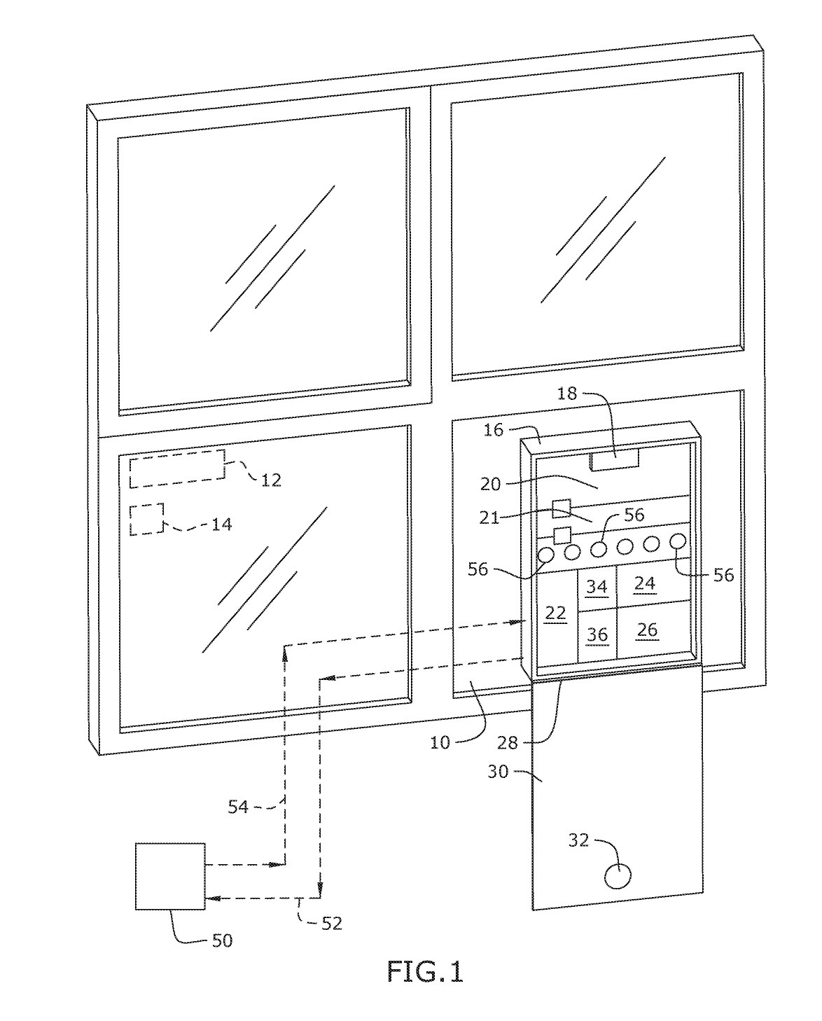

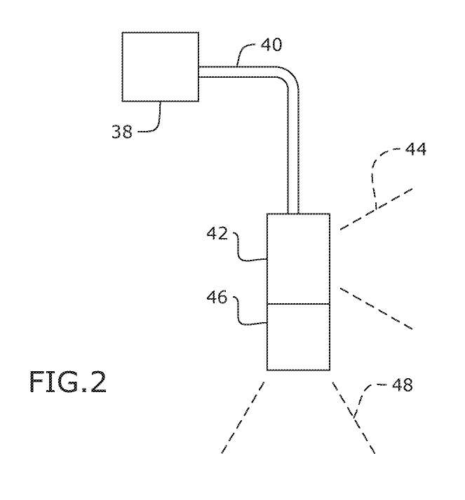

Referring to FIGS. 1 and 2, the present invention includes an alarm system shock detector. The alarm system includes a pressure sensor 21, a transmitter 22 and a computer 20 having a processor and a memory. The pressure sensor 21 detects an amount of pressure applied to a barrier 10. The computer 20 is electrically connected to the pressure sensor 21 and the transmitter 22. The computer 20 receives an input of a threshold pressure amount, receives the amount of pressure from the pressure sensor when a pressure is applied to the barrier, and transmits an alarm signal 52, such as an encrypted alarm signal, to a remote command center 50 via the transmitter 22 when the amount of pressure exceeds the threshold pressure amount.

In certain embodiments, the input is in the form of a code. The code may be manually entered into the computer 20 by a keypad 34. Alternatively, the memory of the computer 20 may store pre-set threshold amounts. A user may quickly change between the pre-set threshold amounts by selecting buttons 56 of the alarm system.

In certain embodiments, the code is a computer readable code 12, 14. For example, the computer readable code 12, 14 is a linear bar code 12 and a matrix bar code 14. In such embodiments, the present invention may include a scanner 42, 46 electrically connected to the computer 20. The linear bar code 12 and the matrix bar code 14 may each include the threshold pressure amount. For example, a window may be the barrier 10. The window manufacturer may print the linear bar code 12 and the matrix bar code 14 and adhere the bar codes 12, 14 to the window. The adhered bar codes 12, 14 may include the threshold amount of pressure for the window to break. The scanner 42, 46 may read the computer readable code 12, 14 and send the threshold amount of the window to the computer 20.

The scanner 42, 46 of the present invention may include a linear scanner 42 having a scanning area 44 and a matrix scanner 46 having a scanning area 48 perpendicular relative to the scanning area 44 of the linear scanner 42. In certain embodiments, the scanner 42, 46 includes a cord 40 and a plug 38. In such embodiments, a plug in port 26 is electrically connected to the computer 20. The plug 38 of the scanner 42, 46 mates with the plug in port 26 to send data from the scanner 42, 46 to the computer 20. In use, the scanner 42, 46 is plugged into the plug in port 26, the scanner 42, 46 is used to scan the computer readable code 12, 14, and the threshold pressure amount is sent to the computer.

As mentioned above, the alarm system wirelessly communicates with the remote command center 50 via the transmitter 22 when the amount of pressure exceeds the threshold pressure amount. In certain embodiments, the alarm system may further include a receiver 24 to receive signals 54, such as an encrypted signal, from the remote command center 50. For example, the remote command center 50 may attempt to communicate with the barrier owner, turn off the alarm, set the threshold level and the like.

In certain embodiments, the present invention includes a housing 16. The housing 16 is secured to the barrier 10. In such embodiments, the computer 20, the pressure sensor 21, the transmitter 22, the receiver 24, the keypad 34, the plug in port 26 and the buttons 56 are disposed within the housing 16. The present invention may further include a door 30 connected to the housing 16 by a hinge 28 and operable to cover and uncover an opening leading into the housing 16. A first locking mechanism 18 of the housing 16 may secured to a second locking mechanism 32 of the door 30 thereby only allowing entry of the housing 16 by an authorized user. The present invention may further include a biometrics identity verification device 36 allowing access to using the keypad 34.

The shock detector can be reconfigured to detect and record impacts to a barrier over a long period of time to determine a barrier breaking point getting weaker. Then the shock detector may determine the weaker barrier threshold and adapt the threshold to the weaker threshold. Then when the weaker threshold is detected, the shock detector is triggered.

The shock detector of the present invention can be used as a shock detector in the ground to detect someone tunneling under the ground. For example, the present invention may be used at prisons or jails to detect prisoner(s) that are tunneling out of the jail(s) and prison(s). The shock detector can also be used to secure a country border by detecting someone digging a tunnel.

It should be understood, of course, that the foregoing relates to exemplary embodiments of the invention and that modifications may be made without departing from the spirit and scope of the invention as set forth in the following claims.

17-20. (canceled)

21. A pressure sensor that will trigger or alert only when at least one precise set threshold is detected.

22. A pressure sensor that has at least one keypad built in or attached or communicates via hard wire or wirelessly to the pressure sensor to input at least one precise threshold in to the pressure sensor.

23. A pressure sensor that receive at least one precise thresholds via electronical means via at least one electronically readable device that reads electronically readable material has at least one threshold stored it the memory of the electronically readable material the electronically reader device communicates via hard wire or wirelessly to the pressure sensor to input at least one precise threshold in to the pressure sensor.

24. A pressure sensor in claim 23 has at least one precise pre-set threshold selectors.
